(19) United States
(12) Patent Application Publication
(10) Pub. No.: US 2025/0225761 A1
(43) Pub. Date: Jul. 10, 2025

(54) IMAGE PROCESSING DEVICE AND IMAGE PROCESSING SYSTEM

(71) Applicant: Samsung Electronics Co., Ltd., Suwon-si (KR)

(72) Inventors: Seo Yeon PARK, Suwon-si (KR); Sung Yong YOU, Suwon-si (KR); Hwan Sung YANG, Suwon-si (KR); Ho Joon LEE, Suwon-si (KR); Sang Gul PARK, Suwon-si (KR)

(21) Appl. No.: 18/925,691

(22) Filed: Oct. 24, 2024

(30) Foreign Application Priority Data
Jan. 8, 2024 (KR) 10-2024-0002763

(51) Int. Cl. G06V 10/25; G06T 3/02; G06T 7/10; G06V 10/762; G06V 10/764

(52) U.S. Cl. CPC G06V 10/25; G06T 3/02; G06T 7/10; G06V 10/762; G06V 10/764; G06T 2207/10061; G06V 2201/07

(57) ABSTRACT

An image processing device and an image processing system are provided. The image processing device comprises a memory, and a processor executing a program stored in the memory, wherein the processor acquires a first image, in which a target region is classified, by applying a segmentation learning model to an image in which the target region is photographed, acquires a second image in which centroid coordinates are displayed in the target region of the first image, generates reference grid coordinates from the centroid coordinates, and calculates a shift value of the target region by using the centroid coordinates and the reference grid coordinates.

### CROSS-REFERENCE TO RELATED APPLICATION

This application claims priority under 35 U.S.C. § 119 from Korean Patent Application No. 10-2024-0002763, filed on Jan. 8, 2024, in the Korean Intellectual Property Office and all the benefits accruing therefrom under 35 U.S.C. § 119, the contents of which in its entirety are herein incorporated by reference.

### BACKGROUND

### Technical Field

The present disclosure relates to an image processing device and an image processing system.

### Description of the Related Art

With the increase in difficulty of developing semiconductor devices, importance in evaluation for processes of semiconductor devices has been increased. The processes of semiconductor devices may be evaluated based on images acquired through scanning electron microscope (SEM) equipment.

It is necessary to increase accuracy of evaluation for the process of the semiconductor device by calculating a shift of each pattern of the semiconductor device using an artificial intelligence model based on the SEM image acquired through the SEM equipment.

### SUMMARY

An object of the present disclosure is to provide an image processing device capable of reliably calculating a shift value of each pattern of a semiconductor device.

Another object of the present disclosure is to provide an image processing system capable of reliably calculating a shift value of each pattern of a semiconductor device.

The objects of the present disclosure are not limited to those mentioned above and additional objects of the present disclosure, which are not mentioned herein, will be clearly understood by those skilled in the art from the following description of the present disclosure.

An image processing device according to some embodiments of the present disclosure to achieve the above objects comprises a memory configured to store instructions, and a processor configured to access the memory and execute the instructions, wherein, when executing the instructions, the processor is configured to acquire a first image, in which a target region is classified, by applying a segmentation learning model to an image in which the target pattern is photographed, acquire a second image in which centroid coordinates are displayed in the target region of the first image, generate reference grid coordinates from the centroid coordinates, and calculate a shift value of the target pattern by using the centroid coordinates and the reference grid coordinates.

An image processing system according to some embodiments of the present disclosure to achieve the above objects comprises a memory configured to store instructions, a processor configured to access the memory and execute the instructions, and an observation device configured to acquire a scanning electron microscope (SEM) image obtained by photographing a plurality of target patterns, wherein, when executing the instructions, the processor is configured to acquire a first image, in which a plurality of target regions are classified, by applying a segmentation learning model to the SEM image, generate a plurality of bounding boxes for each of the plurality of target regions by using an object detection algorithm, acquire a second image in which a plurality of centroid coordinates are displayed for each of the plurality of bounding boxes, generate a plurality of reference grid coordinates from the plurality of centroid coordinates, and calculate a shift value of each of the plurality of target patterns by using the plurality of centroid coordinates and the plurality of reference grid coordinates.

An image processing device according to some embodiments of the present disclosure to achieve the above objects comprises a memory configured to store instructions, and a processor configured to access the memory and execute the instructions, wherein, when executing the instructions, the processor is configured to acquire a first image, in which a plurality of target regions are detected, by applying a segmentation learning model to a scanning electron microscope (SEM) image in which a target pattern is photographed, acquire a second image in which a plurality of centroid coordinates are respectively displayed for each of the plurality of target regions, generate a plurality of reference grid coordinates spaced apart from each other as much as a first distance in first and second horizontal directions by using the plurality of centroid coordinates, and calculate a shift value of each of the plurality of target patterns by using the plurality of centroid coordinates and the plurality of reference grid coordinates.

Details of the other embodiments are included in the detailed description and drawings.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a block diagram illustrating an image processing system according to example embodiments;

FIG. 2 is a view illustrating an object detection module according to example embodiments;

FIG. 3 is a view illustrating a preprocessing module according to example embodiments;

FIG. 4 is a view illustrating a scanning electron microscope (SEM) image acquired by an observation device according to example embodiments;

FIG. 5 is a view illustrating a masking map formed by a segmentation module according to example embodiments;

FIG. 6 is a view illustrating a first image acquired by a segmentation module according to example embodiments;

FIG. 7 is a view illustrating a second image acquired by an object detection module according to example embodiments;

FIG. 8 is a view illustrating centroid coordinates and reference grid coordinates, which are formed by a grid generation module according to example embodiments;

FIGS. 9 to 12 are views illustrating an operation of a first preprocessing module according to example embodiments;

FIG. 13 is a view illustrating an operation of a second preprocessing module according to example embodiments;

FIG. 14 is a view illustrating a third image acquired by a visualization module according to example embodiments;

FIG. 15 is a view illustrating an operation of a calculation module according to example embodiments;

FIGS. 16 to 19 are exemplary views illustrating an image sensor to which an image processing system according to example embodiments may be applied; and

FIG. 20 is an exemplary flow chart illustrating an image processing operation according to example embodiments.

### DETAILED DESCRIPTION OF THE DISCLOSURE

Although the figures described herein may be referred to using language such as “one embodiment,” or “certain embodiments,” these figures, and their corresponding descriptions are not intended to be mutually exclusive from other figures or descriptions, unless the context so indicates. Therefore, certain aspects from certain figures may be the same as certain features in other figures, and/or certain figures may be different representations or different portions of a particular exemplary embodiment. Like reference characters refer to like element throughout.

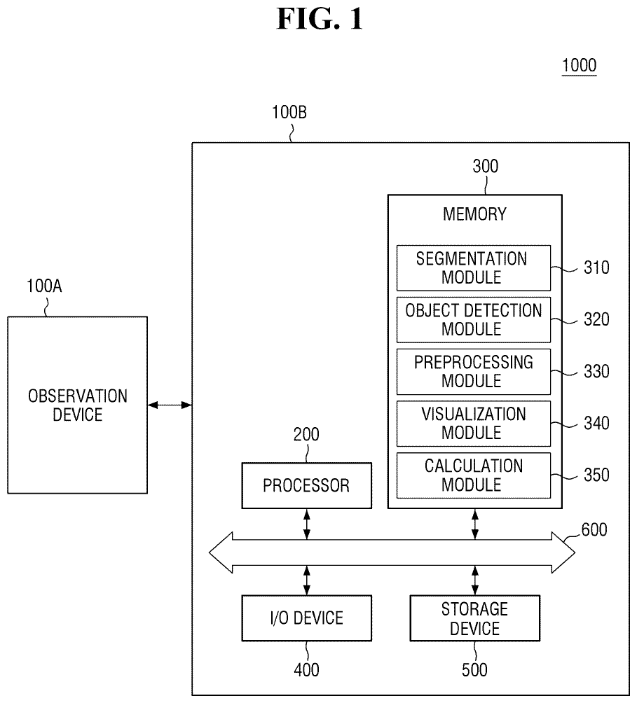

FIG. 1 is a block diagram illustrating an image processing system according to example embodiments.

Referring to FIG. 1, an image processing system 1000 according to some embodiments may include an observation device 100A and an image processing device 100B.

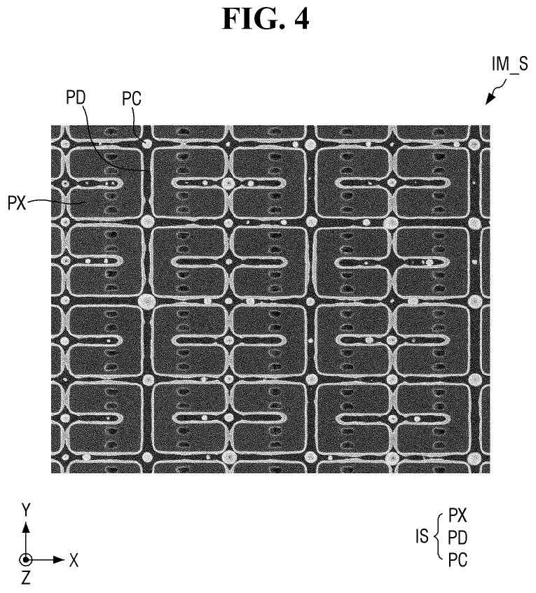

The observation device 100A may be a device for acquiring a scanning electron microscope (SEM) image (e.g., SEM image IM_S of FIG. 4) that will be described later. In example embodiments, the observation device 100A may be a scanning electron microscope (SEM).

The image processing device 100B may include a processor 200, a memory 300, an input/output device 400, a storage device 500, and a bus 600. The image processing device 100B may be implemented as, for example, an integrated device. For example, the image processing device 100B may be provided as an image processing dedicated device. The image processing device 100B may be, for example, a computer for driving various modules for image processing.

The processor 200 may control the image processing device 100B. The processor 200 may execute an operating system, firmware, etc. for driving the image processing device 100B.

For example, the processor 200 may include a core, which is capable of executing any instructions, such as a central processing unit (CPU), a microprocessor, an application processor (AP), a digital signal processor (DSP), and a graphic processing unit (GPU).

The processor 200 may communicate with the memory 300, the input/output device 400, and the storage device 500 through the bus 600. For example, the processor 200 may transmit and/or receive data to and/or from the memory 300, the input/output device 400, and the storage device 500 through the bus 600.

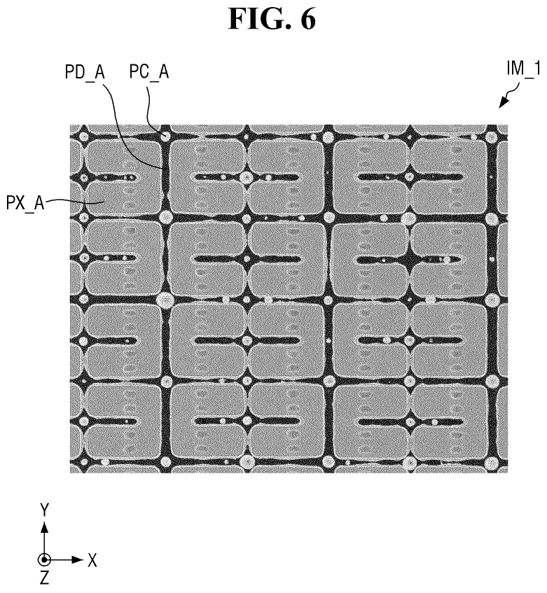

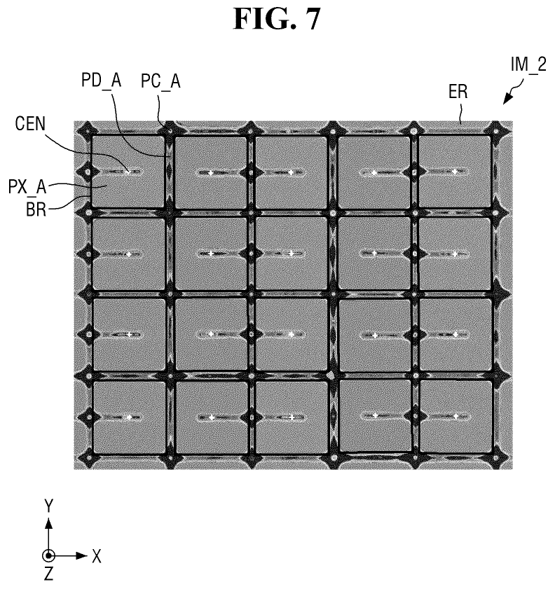

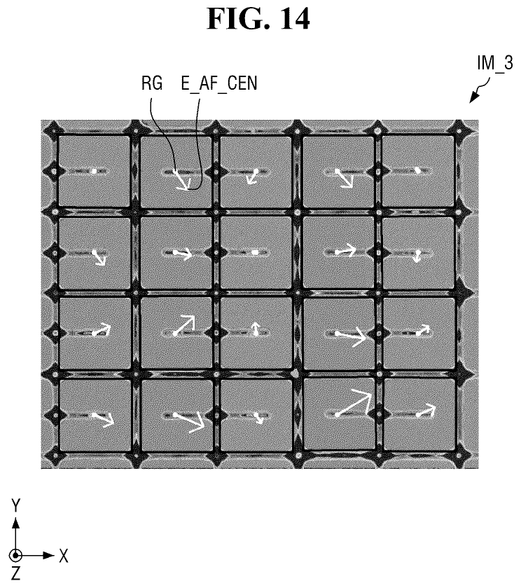

The processor 200 may acquire a first image (e.g., first image IM_1 of FIG. 6) by driving a segmentation module 310 loaded in the memory 300 and applying a segmentation learning model to the SEM image (e.g., SEM image IM_S of FIG. 4). The processor 200 may acquire a second image (e.g., second image IM_2 of FIG. 7) by using an object detection module 320 loaded in the memory 300. The processor 200 may acquire a correction value for centroid coordinates CEN and reference grid coordinates RG by using a preprocessing module 330 loaded in the memory 300. The processor 200 may acquire a third image (e.g., third image IM_3 of FIG. 14) of a shift of a target pattern by using a visualization module 340 loaded in the memory 300. The processor 200 may calculate a shift value of the target pattern by using a calculation module 350 loaded in the memory 300.

The segmentation module 310, the object detection module 320, the preprocessing module 330, the visualization module 340, and the calculation module 350 may be programs or software modules that include a plurality of instructions executed by the processor 200, and may be stored in a computer-readable storage medium.

The memory 300 may store the segmentation module 310, the object detection module 320, the preprocessing module 330, the visualization module 340, and the calculation module 350. The segmentation module 310, the object detection module 320, the preprocessing module 330, the visualization module 340 and the calculation module 350 may be loaded from, for example, the storage device 500.

The memory 300 may be a volatile memory such as static random access memory (SRAM) or dynamic random access memory (DRAM), or may be a nonvolatile memory such as phase-change random access memory (PRAM), magnetic random access memory (MRAM), resistive random access memory (ReRAM), or ferroelectric random access memory (FRAM) NOR flash memory.

The input/output device 400 may control a user input and output from user interface devices. For example, the input/output device 400 may include an input device such as a keyboard, a mouse, and a touch pad to receive various data. For example, the input/output device 400 may include an output device such as a display to display various data and/or a speaker to communicate various data and information.

The storage device 500 may store various data related to the segmentation module 310, the object detection module 320, the preprocessing module 330, the visualization module 340 and the calculation module 350. The storage device 500 may store instructions or codes such as an operating system or firmware, which is executed by the processor 200.

The storage device 500 may include, for example, a memory card (multimedia card (MMC), embedded multimedia card (cMMC), secure digital (SD), MicroSD, etc.), a solid state drive (SSD), a hard disk drive (HDD), etc.

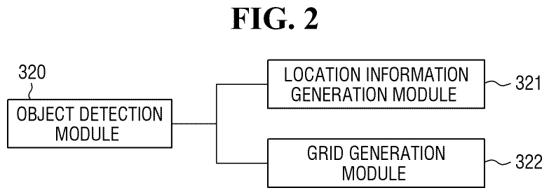

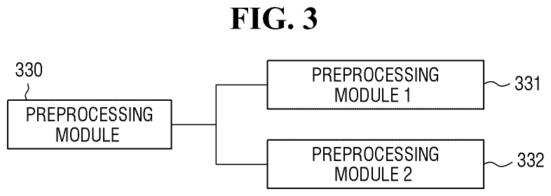

FIG. 2 is a view illustrating an object detection module according to example embodiments. FIG. 3 is a view illustrating a preprocessing module according to example embodiments.

Referring to FIG. 2, the object detection module 320 may include a location information generation module 321 and a grid generation module 322. Referring to FIG. 3, the preprocessing module 330 may include a first preprocessing module 331 (also referred to as preprocessing module 1) and a second preprocessing module 332 (also referred to as preprocessing module 2).

The operation of the object detection module 320 and the preprocessing module 330 will be described later.

FIG. 4 is a view illustrating an SEM image acquired by an observation device according to example embodiments.

The SEM image IM_S may be acquired by the observation device 100A. For example, the observation device 100A may acquire a plurality of SEM images IM_S by photographing a plurality of target patterns PD based on a vertical direction Z. For example, the target pattern PD may mean a pixel separation pattern of an image sensor IS that will be described later, but is not limited thereto.

In this case, the observation device 100A may acquire a plurality of SEM images IM_S by photographing a region from an uppermost region to a lowermost region of the target pattern PD based on the third direction Z that will be described later. The SEM image IM_S of FIG. 4 may be an image of the plurality of SEM images IM_S, which corresponds to any one point based on the third direction Z.

The following description will be based on an embodiment in which the SEM image IM_S is any one image photographed at any one point of the image sensor IS based on the third direction Z.

The SEM image IM_S may be acquired by photographing at least a portion of the image sensor IS based on the third direction Z.

The image sensor IS may include a pixel region PX, a pixel separation pattern PD, and a pixel separation pattern connector PC.

The pixel regions PX may be arranged in the form of an array along first and second directions X and Y crossing each other. Although not shown in detail, each pixel region PX may include a photoelectric conversion layer. The photoelectric conversion layer may generate electric charges in proportion to the amount of light incident from the outside.

The pixel separation pattern PD may define a plurality of pixel regions PX. When viewed in a plan view, the pixel separation patterns PD may be formed in the form of a grid to separate the pixel regions PX. For example, the pixel separation patterns PD may separate the plurality of pixel regions PX from one another. The pixel separation pattern connector PC may mean a region in which the pixel separation patterns PD cross and are connected to each other. For example, the pixel separation pattern connectors PC may refer to regions where the pixel separation patterns PD intersect each other. The pixel separation pattern PD may be formed by patterning a substrate (not shown) on which the pixel region PX is formed. The pixel separation pattern PD may be formed by filling a trench of the substrate with an insulating material. The pixel separation pattern PD may be extended in the third direction Z crossing each of the first and second directions X and Y to be perpendicular thereto.

For example, when the pixel separation pattern PD is formed to pass through the substrate in the third direction Z, the pixel separation pattern PD may be referred to as a frontside deep trench isolation (FDTI). Alternatively, the pixel separation pattern PD may not completely pass through the substrate in the third direction Z. The pixel separation pattern PD may be referred to as a backside deep trench isolation (BDTI).

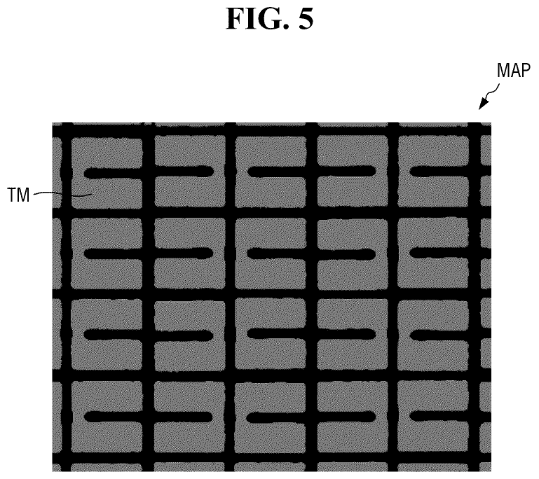

FIG. 5 is a view illustrating a masking map formed by a segmentation module according to example embodiments.

The segmentation module 310 may form a masking map MAP that includes a mask TM for a target region. The masking map MAP may be formed based on pixels of the SEM image (e.g., SEM image IM_S of FIG. 4). The masking map MAP may refer to a label for each pixel.

The segmentation module 310 may generate a first image (e.g., first image IM_1 of FIG. 6) based on the masking map MAP.

FIG. 6 is a view illustrating a first image acquired by a segmentation module according to example embodiments.

The segmentation module 310 may acquire a first image IM_1, in which a target region PX_A is classified, by applying a segmentation learning model to the SEM image (e.g., SEM image IM_S of FIG. 4). The segmentation module 310 may acquire the first image IM_1 by predicting and classifying a type (label) of the target region PX_A. In some embodiments, the target region PX_A may be a region corresponding to the pixel region (e.g., pixel region PX of FIG. 4), but is not limited thereto.

The segmentation module 310 may classify the type (label) of the target region PX_A by using the segmentation learning model. This object classification may be performed using a machine learning algorithm and/or an artificial intelligence model.

For example, the artificial intelligence model may include a panoptic segmentation network, but is not limited thereto. The artificial intelligence model may include an instance segmentation network, FCN, U-Net, DeepLab V3+, or Atrous convolution.

For example, the segmentation learning model may mean a neural network learned to extract features of the target region PX_A and features of an image in which the target region PX_A is included, and classify the target region PX_A based on the extracted features.

For example, the region PX_A corresponding to the pixel region, a region PD_A corresponding to the pixel separation pattern, and a region PC_A corresponding to the pixel separation pattern connector may be displayed and classified in different colors. For example, the segmentation module 310 may acquire the first image IM_1, in which the region PX_A corresponding to the pixel region is classified, by applying the segmentation learning model to the SEM image IM_S in which the pixel separation pattern PD is photographed.

FIG. 7 is a view illustrating a second image acquired by an object detection module according to example embodiments.

The location information generation module 321 may check the existence and location of an object, that is, the target region PX_A, from the first image (e.g., first image IM_1 of FIG. 6) by using a bounding box BR. The location information generation module 321 may respectively fit a plurality of bounding boxes BR for the plurality of target regions PX_A. For example, the location information generation module 321 may generate the bounding box BR at an outer boundary of the region PX_A corresponding to the pixel region by using an object detection algorithm.

The object detection may mean a task of distributing an image by generating a bounding box in a target region in order to divide an image into similar regions in view of a semantic or cognitive aspect. For example, the location information generation module 321 may check the boundary of each object by allocating an object class to each pixel of the image.

The type (class or label) of the target region PX_A may be classified by the segmentation module 310, and location information of the target region PX_A may be acquired by the object detection module 320. Classification and acquisition of location information on the target region PX_A may be performed based on an artificial intelligence model. This may be performed by extracting features of a tracking target and features of an image including the tracking target by using the learned neural network, classifying the target region PX_A based on the extracted features, and acquiring the location information.

The location information generation module 321 may generate the bounding box BR based on an area of the target region PX_A. For example, the location information generation module 321 may perform object detection only for a specific area. For example, referring to FIG. 7, an edge region ER other than the bounding box BR in the second image IM_2 may be automatically excluded from the object detection target. Therefore, only the target region PX_A in the bounding box BR may be an object detection target performed by the location information generation module 321.

Afterwards, the location information generation module 321 may acquire a second image IM_2 in which the centroid coordinates CEN are respectively displayed in the plurality of target regions PX_A. The centroid coordinates CEN may be generated for each of the plurality of bounding boxes BR. The centroid coordinates CEN may be the coordinates for the central point within each of the plurality of bounding boxes BR.

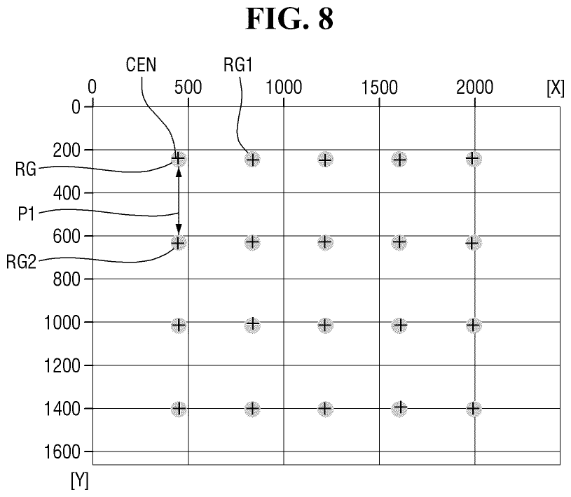

FIG. 8 is a view illustrating centroid coordinates and reference grid coordinates, which are formed by a grid generation module according to example embodiments.

The grid generation module 322 may generate the reference grid coordinates RG from the centroid coordinates CEN.

The reference grid coordinates RG may be generated based on information on the target region PX_A. The reference grid coordinates RG may be generated at locations spaced apart from each other as much as a pitch P1 of the pixel region PX based on the centroid coordinates CEN of the first bounding box BR of the second image IM_2. In detail, the grid generation module 322 may generate first reference grid coordinates RG1 spaced apart as much as the pitch P1 in the first horizontal direction X and second reference grid coordinates RG2 spaced apart as much as the pitch P1 in the second horizontal direction Y. For example, the pitch P1 may be 0.7 μm, but is not limited thereto.

The centroid coordinates CEN may be generated for each target region PX_A. The reference grid coordinates RG may be arranged in the form of a grid at locations spaced apart as much as the pitch P1. Therefore, the plurality of centroid coordinates CEN and the plurality of reference grid coordinates RG, as shown in FIG. 8, may be generated.

Through this process, the plurality of centroid coordinates CEN and the plurality of reference grid coordinates RG corresponding thereto may be generated in the second image IM_2.

Therefore, the preprocessing module 330, which will be described later, may calculate how much the location of the centroid coordinates CEN has been moved compared to the location of the reference grid coordinates RG.

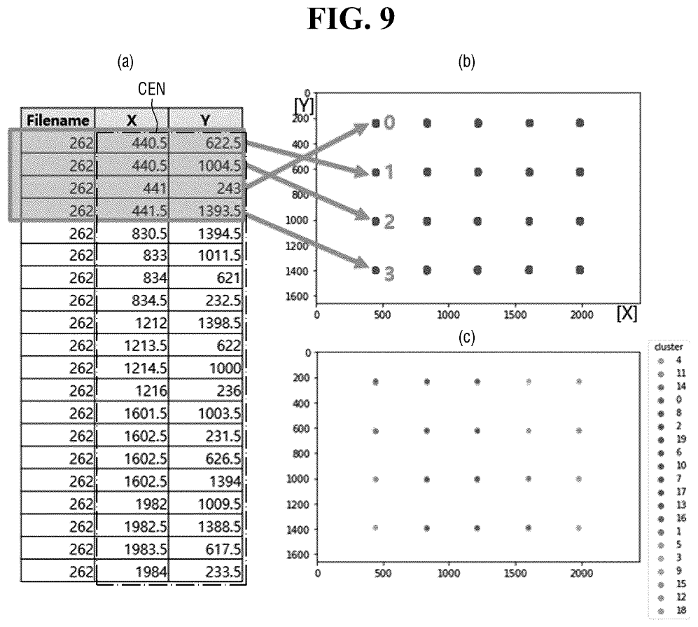

FIGS. 9 to 12 are views illustrating an operation of a first preprocessing module according to example embodiments.

Referring to FIG. 9, the first preprocessing module 331 may group and align the centroid coordinates CEN by using a k-means clustering algorithm. The k-means clustering algorithm may mean a machine learning-based clustering technique that clusters given data into k clusters as data having similar characteristics.

FIG. 9(a) is a view illustrating the centroid coordinates CEN acquired by the location information generation module 321. The centroid coordinates CEN may include centroid coordinate data CEN (x, y) generated from the SEM image (e.g., SEM image IM_S of FIG. 4) photographed at a specific location based on the above-described third direction Z. For example, the centroid coordinates CEN may be generated from the SEM image IM_S photographed at the 262nd point of a total of 263 points based on the third direction Z, but are not limited thereto.

The order of the centroid coordinate data CEN (x, y) may be randomly calculated and aligned. For example, the centroid coordinate data CEN (x, y) may be aligned in 20 rows. In this case, the total number of the centroid coordinate data CEN (x, y) may be 263×20, but is not limited thereto.

FIG. 9(b) is a view illustrating a cluster number matched with centroid coordinate data CEN (x, y).

For example, centroid coordinate data 440.5 and 622.5 of a first row may be matched with cluster number 1, centroid coordinate data 440.5 and 1004.5 of a second row may be matched with cluster number 2, centroid coordinate data 441 and 243 of a third row may be matched with cluster number 0, and centroid coordinate data 441.5 and 1393.5 of a fourth row may be matched with cluster number 3. However, due to a shift phenomenon of the target pattern, it is difficult to align the centroid coordinate data CEN (x, y) in due order by the conventional centroid coordinate CEN.

FIG. 9(c) is a view illustrating that the centroid coordinate data CEN (x, y) are allocated to a cluster number.

The first preprocessing module 331 may generate 20 clusters for the centroid coordinate data CEN (x, y) for each similar location by applying the aforementioned k-means clustering algorithm and allocate the centroid coordinate data CEN (x, y) corresponding to the matched cluster number to the generated cluster.

For example, the centroid coordinate data 441 and 243 corresponding to the matched cluster number 0 of FIG. 9(b) may be allocated to the cluster number 0 of the generated cluster in FIG. 9(c), the centroid coordinate data 440.5 and 622.5 corresponding to the matched cluster number 1 of FIG. 9(b) may be allocated to cluster number 14 of the generated cluster in FIG. 9(c), and the centroid coordinate data 440.5 and 1004.5 corresponding to the matched cluster number 2 of FIG. 9(b) may be allocated to cluster number 11 of the generated cluster of FIG. 9(c), and the centroid coordinate data 441.5 and 1393.5 corresponding to the matched cluster number 3 of FIG. 9(b) may be allocated to cluster number 4 of the generated cluster of FIG. 9(c).

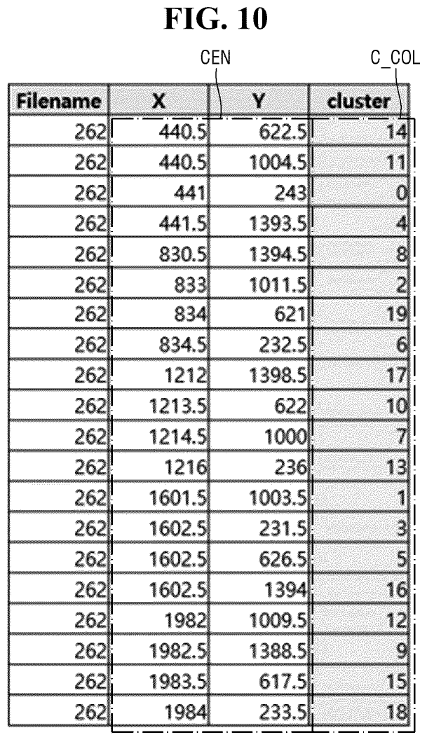

Afterwards, referring to FIG. 10, the cluster numbers may be realigned in due order. For example, the first preprocessing module 331 may generate a cluster column C_COL, which includes cluster numbers respectively corresponding to the centroid coordinate data CEN (x, y), by using the k-means clustering algorithm.

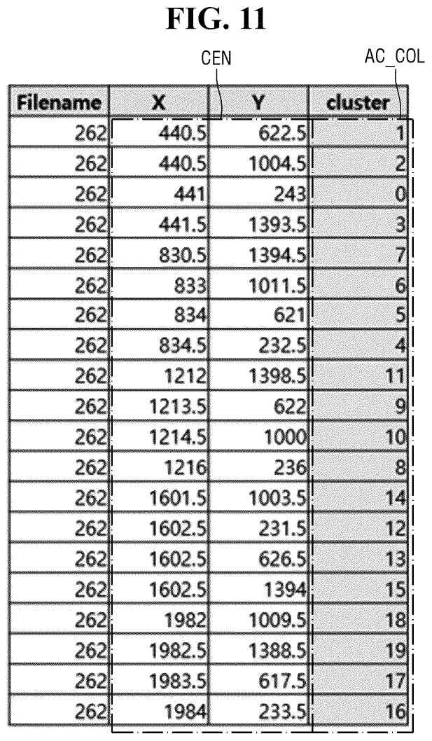

Afterwards, referring to FIG. 11, the first preprocessing module 311 may check the cluster number for each location and reallocate the cluster numbers in the order of the location of the pixel region PX to generate a reallocated cluster column AC_COL.

For example, referring to FIGS. 10 and 11, the centroid coordinate data CEN (x, y) corresponding to the aligned cluster number 14 of FIG. 10 may be reallocated to cluster number 1 of FIG. 11, the centroid coordinate data CEN (x, y) corresponding to the aligned cluster number 11 of FIG. 10 may be reallocated to cluster number 2 of FIG. 11, the centroid coordinate data CEN (x, y) corresponding to the aligned cluster number 0 of FIG. 10 may be reallocated to cluster number 0 of FIG. 11, and the centroid coordinate data CEN (x, y) corresponding to the aligned cluster number 4 of FIG. 10 may be reallocated to cluster number 3 of FIG. 11. The reallocated cluster number may mean a desired actual location of the centroid coordinates CEN (x, y).

Therefore, each cluster number and the actual location of the centroid coordinates CEN (x, y) may be mapped.

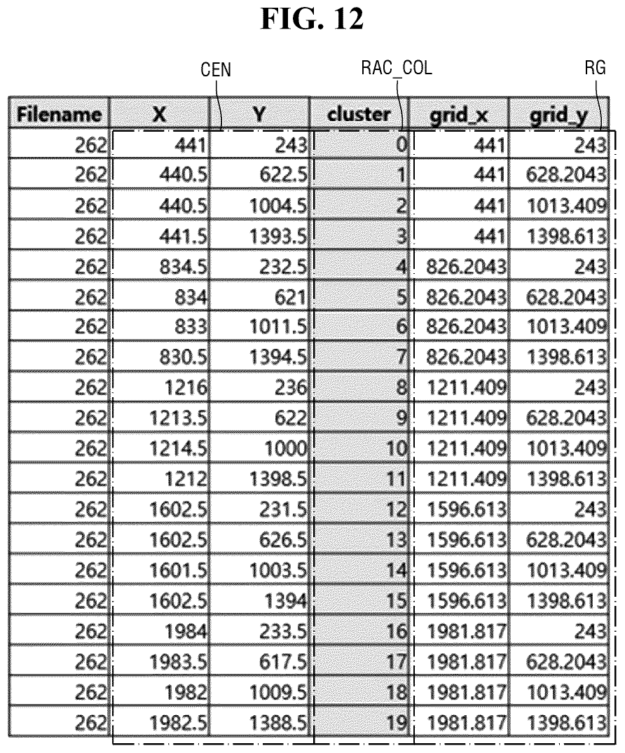

Afterwards, referring to FIG. 12, the first preprocessing module 331 may realign the cluster numbers of the reallocated cluster column AC_COL in due order to generate a realigned cluster column RAC_COL. Therefore, the reference grid coordinates RG and the centroid coordinates CEN may be matched with each other. For example, the reference grid coordinate data 441 and 243 of the first row may be identically matched with the centroid coordinate data 441 and 243 of the first row, which are the leftmost centroid coordinates CEN of the second image IM_2 in FIG. 7.

Afterwards, the realigned cluster column RAC_COL may be removed.

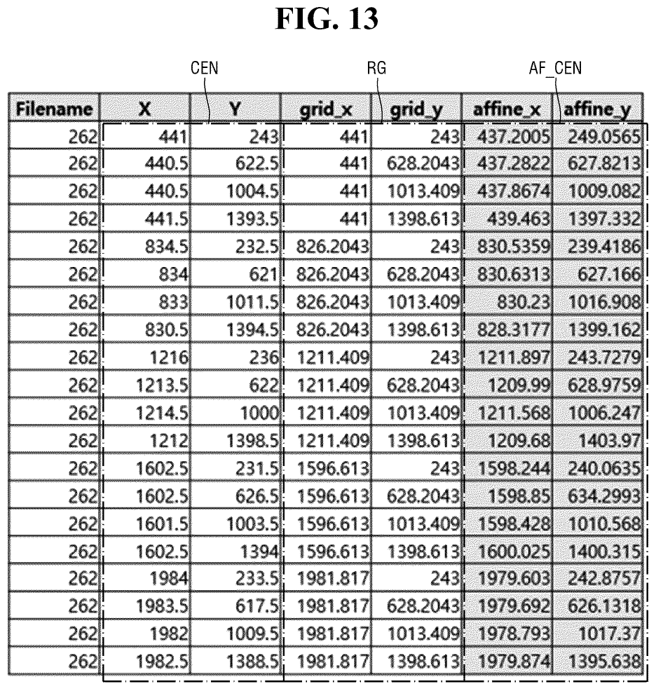

Referring to FIG. 13, the second preprocessing module 332 may generate affine transformation centroid coordinates AF_CEN by performing affine transformation for the centroid coordinates CEN. In detail, the second preprocessing module 332 may generate the affine transformation centroid coordinates AF_CEN by using an affine transformation matrix modeled to minimize an error estimated between the centroid coordinates CEN and the reference grid coordinates RG.

The affine transformation is a prior mapping method that preserves points, straight lines and planes, and parallel lines may be maintained in a parallel state even after the affine transformation. The affine transformation may be used to correct geometric distortion or shape deformation, which mainly occurs at a lens angle that is not ideal. Therefore, it is possible to acquire the centroid coordinates from which image distortion is removed.

The following Equation (1) exemplarily illustrates an affine transformation matrix applied to some embodiments. In the affine transformation matrix of the Equation (1), affine transformation coefficients, that is, ‘a’ may be an enlargement/downsizing ratio in the direction X, ‘b’ may be shear transformation in the direction X, ‘c’ may be a movement amount in the direction X, ‘d’ may be an enlargement/downsizing ratio in the direction Y, ‘e’ may be shear transformation in the direction Y, and ‘f’ may be a movement amount in the direction Y. X₁ and Y₁ may mean the centroid coordinates CEN, and X₂ and Y₂ may mean the reference grid coordinates RG.

$$[ \begin{matrix}{X}_{2} \\ {Y}_{2} \\ 1\end{matrix} ] = [ \begin{matrix}a & b & c \\ d & e & f \\ 0 & 0 & 1\end{matrix} ] [ \begin{matrix}{X}_{1} \\ {Y}_{1} \\ 1\end{matrix} ] \qquad Equation ( 1 )$$

The second preprocessing module 332 may acquire the corrected centroid coordinates AF_CEN by performing affine transformation for the centroid coordinates CEN based on the above-described transformation conditions.

For example, an affine transformation matrix, which uses the centroid coordinates CEN as an independent variable and the reference grid coordinates RG as a dependent variable, is generated by the second preprocessing module 332, and each centroid coordinate CEN may be affine-transformed using the affine transformation matrix. For example, when a total of 263 SEM images IM_S are photographed by, for example, the observation device 100A, 263 affine transformation centroid coordinate data affine_x and affine_y may be generated.

FIG. 14 is a view illustrating a third image acquired by the visualization module.

Referring to FIG. 14, a third image IM_3 for a shift shape of a target pattern may be acquired, by the visualization module 340, using an arrow for connecting the reference grid coordinates RG with the affine transformation centroid coordinates AF_CEN.

In detail, a start point of the arrow may be the reference grid coordinate RG, and an end point of the arrow may be outer point coordinates E_AF_CEN connecting the affine transformation centroid coordinates AF_CEN with the reference grid coordinates RG.

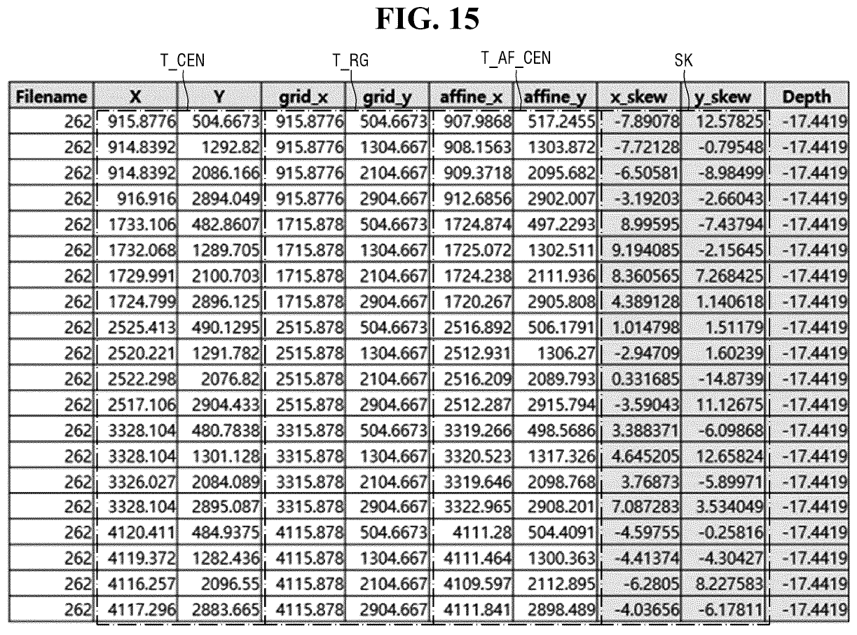

A length of the arrow may mean a value acquired by multiplying a distance between the affine transformation centroid coordinates AF_CEN and the reference grid coordinates RG by a specific coefficient. For example, the length of the arrow may mean a value acquired by multiplying the distance between the affine transformation centroid coordinates AF_CEN and the reference grid coordinates RG by 15, but is not limited thereto. FIG. 15 is a view illustrating an operation of a calculation module.

Referring to FIG. 15, a unit transformation condition may be applied to each of the centroid coordinates CEN, the reference grid coordinates RG, and the affine-transformed centroid coordinates AF-CEN of FIG. 13, so that unit transformed centroid coordinates T_CEN, unit transformed reference grid coordinates T_RG, and unit transformed affine transformation centroid coordinates T_AF_CEN may be generated. The unit transformation condition may mean, for example, a relationship of 2.07682 nm per pixel (1 Pixel=2.07682 nm).

The calculation module 350 may generate a skew value column SK by using a difference between the unit transformed affine transformation centroid coordinates T_AF_CEN and the unit transformed reference grid coordinates T_RG.

In detail, the calculation module 350 may calculate an x skew value x_skew by using a difference between unit transformed affine transformation centroid x-coordinate data (affine_x of FIG. 15) and unit transformed reference grid x-coordinate data (grid_x of FIG. 15). Also, the calculation module 350 may calculate a y skew value y_skew by using a difference between unit transformed affine transformation centroid y-coordinate data (affine_y of FIG. 15) and unit transformed reference grid y-coordinate data (grid_y of FIG. 15).

In addition, the calculation module 350 may calculate the x and y skew values of the target pattern at a specific point (depth) based on the third direction Z.

For example, the calculation module 350 may calculate the x skew value x_skew and the y skew value y_skew at a depth of 17.4419 nm from an uppermost surface of the pixel separation pattern (PD of FIG. 4) at a point from the uppermost surface of the pixel separation pattern (PD of FIG. 4) to a lowest surface (depth of 4500 nm from the upper surface of the pixel separation pattern).

In addition, the calculation module 350 may calculate a root mean square value for each of the calculated x skew value x_skew and the calculated y skew value y_skew. The calculation module 350 may acquire an absolute value for each of the calculated x skew value x_skew and the calculated y skew value y_skew, and may calculate a maximum value of the absolute value for each of the calculated x skew value x_skew and the calculated y skew value y_skew. Therefore, a maximum shift value of the target pattern in the direction X and a maximum shift value of the target pattern in the direction Y may be calculated, respectively.

Based on the above-described skew value, a shift value at a specific point of the target pattern may be calculated based on the vertical direction Z. For example, the shift value of the pixel separation pattern (e.g., pixel separation patterns PD of FIG. 4) may be greater in a region adjacent to the upper end of the pixel separation pattern (e.g., pixel separation patterns PD of FIG. 4) based on the vertical direction Z.

Meanwhile, the coordinate data described with reference to FIGS. 9 to 15 are not limited to the numerical values shown in the drawings.

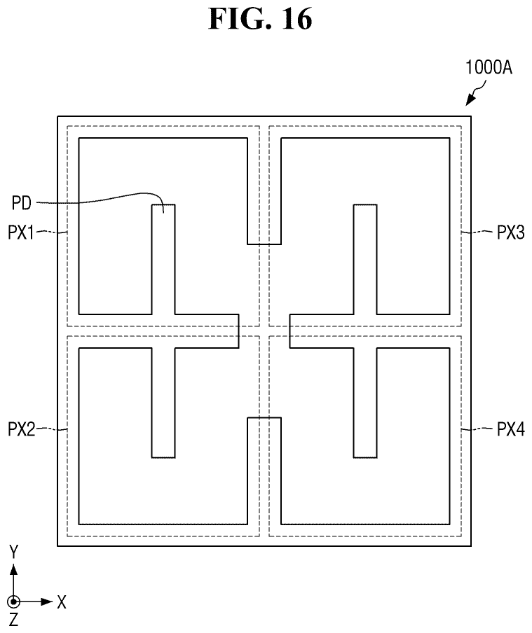

FIGS. 16 to 19 are exemplary views illustrating an image sensor to which an image processing system according to example embodiments may be applied. For convenience of description, a redundant description of the description made with reference to FIGS. 1 to 15 may not be repeated.

Referring to FIG. 16, an image sensor 1000A may include four merged pixel regions (i.e., first, second, third, and fourth pixel regions PX1, PX2, PX3 and PX4) and pixel separation patterns PD therebetween.

The image processing system according to some embodiments may be used to analyze a size and a direction of the pixel separation pattern PD that is shifted, in the image sensor in which the four adjacent pixel regions PX1, PX2, PX3 and PX4 are merged.

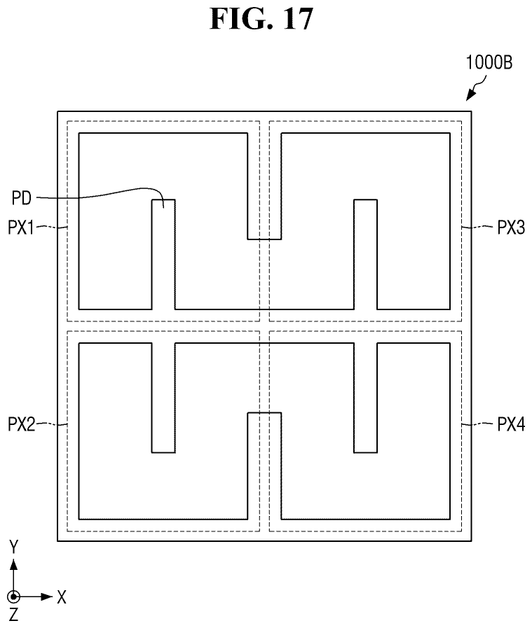

Referring to FIG. 17, an image sensor 1000B may include two merged pixel regions in the first direction X (i.e., first and third pixel regions PX1 and PX3), two merged pixel regions in the second direction Y (i.e., second and fourth pixel regions PX2 and PX4), and a pixel separation pattern PD therebetween. The two merged first and third pixel regions PX1 and PX3 may be adjacent to each other in the first direction X, and the two merged second and fourth pixel regions PX2 and PX4 may be adjacent to each other in the first direction X.

The image processing system according to some embodiments may be used to analyze a size and a direction of the pixel separation pattern PD that is shifted, in an image sensor having two merged pixel regions adjacent to each other in the first direction X.

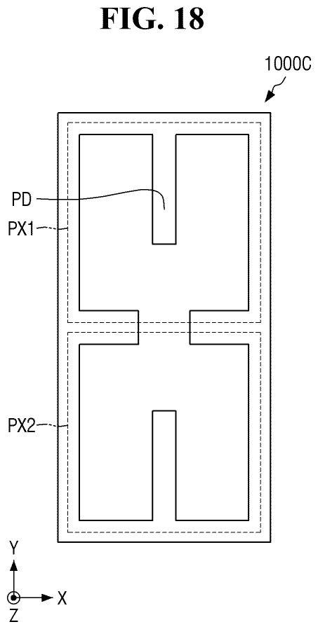

Referring to FIG. 18, an image sensor 1000C may include two merged pixel regions in the second direction Y (i.e., first and second pixel regions PX1 and PX2) and a pixel separation pattern PD therebetween. The two merged first and second pixel regions PX1 and PX2 may be adjacent to each other in the second direction Y.

The image processing system according to some embodiments may be used to analyze a size and a direction of the pixel separation pattern PD that is shifted, in an image sensor having two merged pixel regions adjacent to each other in the second direction Y.

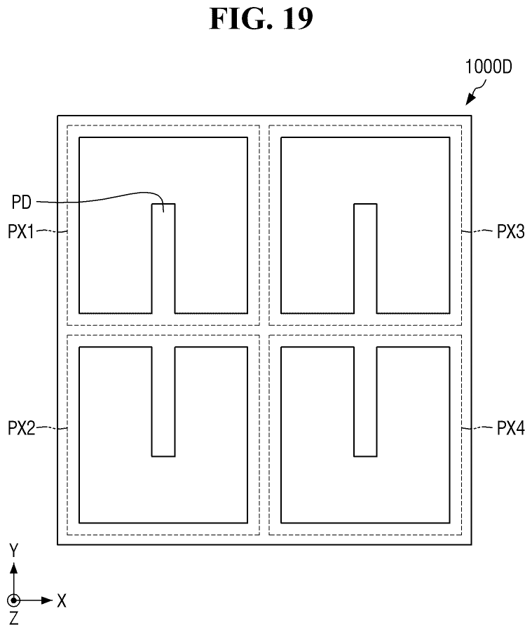

Referring to FIG. 19, an image sensor 1000D may include four pixel regions PX1, PX2, PX3 and PX4 separated from one another and pixel separation patterns PD therebetween.

The image processing system according to some embodiments may be used to analyze a size and a direction of the pixel separation pattern PD that is shifted, in an image sensor in which four adjacent pixel regions PX1, PX2, PX3 and PX4 are not merged.

Furthermore, the image processing system according to some embodiments may be used to analyze a size and a direction of a nano pattern that is shifted, in an image sensor including a prism structure in which the nano pattern is disposed.

The image processing system according to some embodiments may be used to analyze a size and a direction of contact patterns that are shifted, in a semiconductor device that includes the contact patterns for connecting wiring layers.

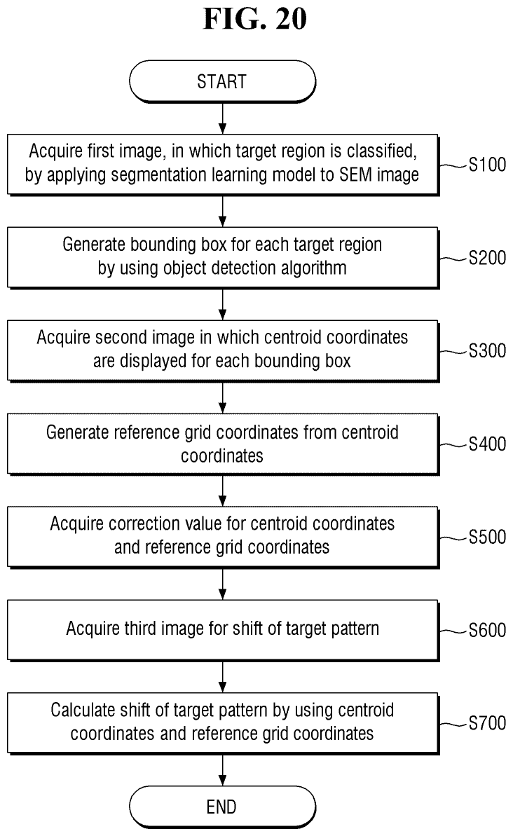

FIG. 20 is an exemplary flow chart illustrating an image processing operation according to example embodiments. For convenience of description, a redundant description of the description made with reference to FIGS. 1 to 19 may not be repeated.

Referring to FIG. 20, the segmentation module 310 according to some embodiments may acquire a first image IM_1, in which a target region is classified, by applying a segmentation learning model to an SEM image (S100).

Afterwards, the object detection module 320 may generate a bounding box BR for each target region by using an object detection algorithm (S200). Then, the object detection module 320 may acquire a second image IM_2 in which centroid coordinates CEN are displayed for each bounding box BR (S300).

Afterwards, the object detection module 320 may generate reference grid coordinates RG from the centroid coordinates CEN (S400).

Afterwards, the preprocessing module 330 may acquire a correction value for the centroid coordinates CEN and the reference grid coordinates RG (S500).

Afterwards, the visualization module 340 may acquire a third image IM_3 for a shift of a target pattern (S600).

Afterwards, the calculation module 350 may calculate a shift size and a shift direction of the target pattern by using the centroid coordinates CEN and the reference grid coordinates RG (S700).

Although the embodiments of the present disclosure have been described with reference to the accompanying drawings, it will be apparent to those skilled in the art that the present disclosure can be manufactured in various forms without being limited to the above-described embodiments and can be embodied in other specific forms without departing from the technical spirits and essential characteristics. Thus, the above embodiments are to be considered in all respects as illustrative and not restrictive.

What is claimed is:

1. An image processing device comprising:
a memory configured to store instructions; and
a processor configured to access the memory and execute the instructions,
wherein, when executing the instructions, the processor is configured to:
acquire a first image, in which a target region is classified, by applying a segmentation learning model to an image in which the target region is photographed,
acquire a second image in which centroid coordinates are displayed in the target region of the first image,
generate reference grid coordinates from the centroid coordinates, and
calculate a shift value of the target region by using the centroid coordinates and the reference grid coordinates.

2. The image processing device of claim 1, wherein the processor is further configured to acquire the first image by using a plurality of scanning electron microscope (SEM) images obtained by photographing the target region at different locations based on a vertical direction.

3. The image processing device of claim 1, wherein the processor is further configured to generate a bounding box for the target region by using an object detection algorithm, and generate the centroid coordinates for the bounding box.

4. The image processing device of claim 3, wherein the bounding box is generated based on an area of the target region.

5. The image processing device of claim 1, wherein the processor is further configured to generate the reference grid coordinates at a location spaced apart from the centroid coordinates as much as a first horizontal distance.

6. The image processing device of claim 1, wherein the processor is further configured to generate a cluster number matched with the centroid coordinates by using a k-means clustering algorithm.

7. The image processing device of claim 6, wherein the processor is further configured to generate the reference grid coordinates matched with the centroid coordinates by using the cluster number.

8. The image processing device of claim 1, wherein the processor is further configured to generate affine transformation centroid coordinates by performing affine transformation for the centroid coordinates.

9. The image processing device of claim 8, wherein the processor is further configured to acquire a third image by using the reference grid coordinates and the affine transformation centroid coordinates.

10. The image processing device of claim 8, wherein the processor is further configured to calculate a skew value of the target region by using the affine transformation centroid coordinates and the reference grid coordinates.

11. An image processing system comprising:
a memory configured to store instructions;
a processor configured to access the memory and execute the instructions; and
an observation device configured to acquire a scanning electron microscope (SEM) image obtained by photographing a plurality of target patterns,
wherein, when executing the instructions, the processor is configured to:
acquire a first image, in which a plurality of target regions are classified, by applying a segmentation learning model to the SEM image,
generate a plurality of bounding boxes for each of the plurality of target regions by using an object detection algorithm,
acquire a second image in which a plurality of centroid coordinates are displayed for each of the plurality of bounding boxes,
generate a plurality of reference grid coordinates from the plurality of centroid coordinates, and
calculate a shift value of each of the plurality of target patterns by using the plurality of centroid coordinates and the plurality of reference grid coordinates.

12. The image processing system of claim 11, wherein the observation device is configured to acquire a plurality of SEM images by photographing the plurality of target patterns at different locations based on a vertical direction.

13. The image processing system of claim 11, wherein the processor is further configured to exclude an edge region of the second image, which is other than the plurality of bounding boxes, from an application target of the object detection algorithm.

14. The image processing system of claim 11, wherein the processor is further configured to generate first reference grid coordinates spaced apart from each other as much as a first distance in a first horizontal direction and second reference grid coordinates spaced apart from each other as much as the first distance in a second horizontal direction, based on first centroid coordinates of the plurality of centroid coordinates.

15. The image processing system of claim 11, wherein the processor is further configured to generate a plurality of cluster numbers matched with each of the plurality of centroid coordinates by using a k-means clustering algorithm, and generates the plurality of reference grid coordinates matched with each of the plurality of centroid coordinates by using the plurality of cluster numbers.

16. The image processing system of claim 11, wherein the processor is further configured to generate affine transformation centroid coordinates by performing affine transformation for the centroid coordinates.

17. The image processing system of claim 16, wherein the processor is further configured to calculate the shift value of each of the plurality of target patterns by using outer point coordinates of the plurality of reference grid coordinates and the affine transformation centroid coordinates.

18. The image processing system of claim 16, wherein the processor is further configured to respectively calculate skew values of the plurality of target patterns by using the affine transformation centroid coordinates and the plurality of reference grid coordinates.

19. An image processing device comprising:
a memory configured to store instructions; and
a processor configured to access the memory and execute the instructions, wherein, when executing the instructions, the processor is configured to:
acquire a first image, in which a plurality of target regions are detected, by applying a segmentation learning model to a scanning electron microscope (SEM) image in which a target pattern is photographed,
acquire a second image in which a plurality of centroid coordinates are respectively displayed for each of the plurality of target regions,
generate a plurality of reference grid coordinates spaced apart from each other as much as a first distance in first and second horizontal directions by using the plurality of centroid coordinates, and
calculate a shift value of each of the plurality of target regions by using the plurality of centroid coordinates and the plurality of reference grid coordinates.

20. The image processing device of claim 19, wherein the processor is further configured to:
generate a plurality of affine transformation centroid coordinates by performing affine transformation for the plurality of centroid coordinates, and
calculate the shift value of each of the plurality of target regions by using outer point coordinates of the plurality of reference grid coordinates and the plurality of affine transformation centroid coordinates.
